(19) United States
(12) Patent Application Publication
(10) Pub. No.: US 2026/0088497 A1
(43) Pub. Date: Mar. 26, 2026

(54) LOW-COST METAL CAVITY PHASE SHIFTER ASSEMBLIES HAVING METAL HOUSINGS WITH REMOVABLE FRONT COVERS

(71) Applicant: Outdoor Wireless Networks LLC, Richardson, TX (US)

(72) Inventors: Yabing Liu, Suzhou (CN); PuLiang Tang, Suzhou (CN); YueMin Li, Suzhou (CN)

(21) Appl. No.: 19/310,052

(22) Filed: Aug. 26, 2025

(30) Foreign Application Priority Data
Sep. 24, 2024 (CN) 202411331402X

(51) Int. Cl. H01Q 3/34; H01Q 1/24; H01Q 13/18

(52) U.S. Cl. CPC H01Q 3/34; H01Q 1/246; H01Q 13/18

(57) ABSTRACT

A cavity phase shifter comprises a metal housing that extends along a longitudinal axis, the metal housing having a first sidewall and a second sidewall that are connected by a first rear wall to define a first cavity having an open front and a metal cover that is positioned in front of the open front of the first cavity.

### CROSS-REFERENCE TO RELATED APPLICATION

The present application claims priority under 35 U.S.C. § 119 to Chinese Patent Application No. 202411331402.X, filed Sep. 24, 2024, the entire content of which is incorporated herein by reference.

### FIELD OF THE INVENTION

The present disclosure relates to communications systems and, in particular, to base station antennas for cellular communications systems

### BACKGROUND

Cellular communications systems are well known in the art. In a cellular communications system, a geographic area is divided into a series of regions that are referred to as “cells” which are served by respective base stations. Each base station may include one or more base station antennas that are configured to provide two-way radio frequency (“RF”) communications with mobile subscribers that are within the cell served by the base station. Typically, the base station antennas are mounted on a tower, with the radiation patterns (also referred to herein as “antenna beams”) that are generated by the base station antennas directed outwardly.

A common base station configuration is the three-sector configuration in which a cell is divided into three 120° “sectors” in the azimuth (horizontal) plane. A separate base station antenna provides coverage (service) to each sector. Typically, each base station antenna will include multiple vertically-extending columns of radiating elements that operate, for example, using second generation (“2G”), third generation (“3G”) or fourth generation (“4G”) cellular network protocols. These vertically-extending columns of radiating elements are typically referred to as “linear arrays” and the radiating elements in the linear array are all coupled to the same feed network so that each radiating element will transmit a sub-component of the same RF signal. It will be appreciated that these vertically-extending columns of radiating elements may be straight columns or may be columns in which some of the radiating elements are staggered horizontally or have two radiating elements that are horizontally aligned, as offsetting some radiating elements in the horizontal direction acts to narrow the beamwidths of the generated antenna beams in the azimuth (horizontal) plane. Herein, the term “linear array” is used broadly to encompass all of the above configurations. Most modern base station antennas include both “low-band” linear arrays of radiating elements that support service in some or all of the 617-960 MHz frequency band and “mid-band” linear arrays of radiating elements that support service in some or all of the 1427-2690 MHz frequency band. These linear arrays are typically formed using dual-polarized radiating elements, which allows each linear array to be connected to a pair of radio ports so that the linear array can simultaneously transmit and receive RF signals at two orthogonal polarizations (i.e., an antenna beam is generated at each orthogonal polarization).

An RF signal that is to be transmitted by one of the above-discussed linear arrays is generated in a radio and output through a radio port that is connected (e.g., by a coaxial cable) to the base station antenna. The base station antenna divides the RF signal into a plurality of sub-components, and each sub-component of the RF signal is fed to a respective subset of the radiating elements in the linear array (e.g., to one to three radiating elements). The sub-components of the RF signal are transmitted through the radiating elements in the respective subsets to generate an antenna beam that covers a generally fixed coverage area, such as a 120° sector of a cell. Typically these linear arrays will have remote electronic tilt (“RET”) capabilities which allow a cellular operator to electronically change the pointing angle of the generated antenna beams in the elevation (vertical) plane (referred to as the “downtilt angle”) in order to change the size of the sector served by the linear array. Since the antenna beams generated by the above-described 2G/3G/4G linear arrays are static antenna beams that only change in shape due to adjustments in the downtilt angle of the antenna beam, they are often referred to as “passive” linear arrays.

Cellular operators are currently upgrading their networks to support fifth generation (“5G”) cellular service. One important component of 5G cellular service is the use of multi-column “active” beamforming arrays that operate in conjunction with beamforming radios. The beamforming radios set the amplitudes and/or phases of the sub-components of an RF signal that is to be transmitted so that the sub-components will constructively combine in certain directions when transmitted by the radiating elements of the beamforming array. The beamforming radio may transmit different RF signals in the time slots of a time division multiple access scheme so that different antenna beams are generated in different sets of the time slots. The amplitudes and phases of the sub-components of each different RF signal are set so that the active beamforming array generates antenna beams having different sizes, shapes and/or pointing directions on a time-slot-by-time-slot basis. These active beamforming arrays are typically formed using “high-band” radiating elements that operate in higher frequency bands, such as some or all of the 3.3-4.2 GHz and/or the 5.1-5.8 GHz frequency bands, although active beamforming radios may also be provided that operate in other frequency bands such as the upper portion (e.g., 2.5-2.7 GHz) of the mid-band frequency range. The radiating elements in each vertically-extending column of such an active beamforming array are typically coupled to a respective port of a beamforming radio so that each column of radiating elements is fed a different sub-component of the signal to be transmitted. The beamforming radio may be a separate device, or may be integrated with the active antenna array. These active beamforming arrays may generate antenna beams having narrowed beamwidths in the azimuth plane (and hence higher antenna gain). These narrowed antenna beams can be electronically steered throughout the sector by proper selection of the amplitudes and phases of the sub-components of each different RF signal. In order to avoid having to increase the number of antennas at cell sites, 5G antennas that include such beamforming arrays also often include passive linear arrays that support legacy 2G, 3G and/or 4G cellular services.

### SUMMARY

Pursuant to embodiments of the present invention, cavity phase shifter assemblies are provided that comprise a metal housing that extends along a longitudinal axis, the metal housing having a first sidewall and a second sidewall that are connected by a rear wall to define a first cavity having an open front and a metal cover that is positioned in front of the open front of the first cavity.

In some embodiments, the metal cover includes a plurality of openings that provide access to the first cavity.

In some embodiments, the metal housing further comprises a first lip that extends away from the first cavity and a second lip that extends away from the first cavity. In some embodiments, the first lip extends in parallel to a major surface of the metal cover and the second lip also extends in parallel to the major surface of the metal cover.

In some embodiments, the cavity phase shifter assembly further comprises a dielectric material that is interposed between the metal housing and the metal cover. In some cases, the dielectric material may be a gasket.

In some embodiments, the metal housing may further comprise a third sidewall and a fourth sidewall that are connected by a second rear wall to define a second cavity having an open front. The metal cover may also be positioned in front of the open front of the second cavity.

In some embodiments, a plurality of connectors attach the metal housing to the metal cover.

In some embodiments, the metal housing comprises sheet metal. In other embodiments, the metal housing comprises metallized plastic. In some embodiments, the metal cover comprises sheet metal. In some embodiments, the metal cover comprises a reflector of a base station antenna.

In some embodiments, the cavity phase shifter assembly further comprises a phase shifter printed circuit board in the first cavity, where the phase shifter printed circuit board includes a forwardly-extending tab that extends through a first of the openings in the metal cover. In some embodiments, a rear edge of the phase shifter printed circuit board contacts a rear wall of the metal housing.

Pursuant to further embodiments of the present invention, cavity phase shifter assemblies are provided that comprise a metal housing that includes a first cavity that has an open front and a second cavity that has an open front, a first phase shifter assembly in the first cavity, a second phase shifter assembly in the second cavity, and a metal cover that is positioned in front of the open front of the first cavity and the open front of the second cavity.

In some embodiments, the metal cover includes a plurality of openings that provide access to the first cavity and to the second cavity.

In some embodiments, the metal housing comprises a first sidewall and a second sidewall that are connected by a first rear wall to define the first cavity, and a third sidewall and a fourth sidewall that are connected by a second rear wall to define the second cavity. In some embodiments, the metal housing further comprises a first lip that extends away from the first cavity and a second lip that extends away from the first cavity and toward the second cavity. In some embodiments, the first lip extends in parallel to a major surface of the metal cover and the second lip also extends in parallel to the major surface of the metal cover.

In some embodiments, the cavity phase shifter assembly further comprises a separator that is interposed between the metal housing and the metal cover. The separator may comprise, for example, a resilient conductive separator or a dielectric separator.

In some embodiments, a plurality of connectors attach the metal housing to the metal cover.

In some embodiments, the metal housing comprises sheet metal. In other embodiments, the metal housing comprises metallized plastic. In some embodiments, the metal cover comprises sheet metal.

In some embodiments, the metal cover comprises a portion of a reflector of a base station antenna.

In some embodiments, the cavity phase shifter assembly further comprises a first phase shifter printed circuit board in the first cavity and a second phase shifter printed circuit board in the second cavity, where the first phase shifter printed circuit board includes a forwardly-extending tab that extends through a first of the openings in the metal cover.

Pursuant to additional embodiments of the present invention, cavity phase shifter assemblies are provided that comprise a metal housing that extends along a first longitudinal axis and a metal cover. The metal housing comprises a first sidewall, a second sidewall, a rear wall that connects the first sidewall to the second sidewall, a first lip that extends outwardly from a front edge of the first sidewall, and a second lip that extends outwardly from a front edge of the second sidewall. The metal cover extends in parallel to the first and second lips

In some embodiments, the first sidewall, the second sidewall and the rear wall define a first cavity having an open front, and the metal cover is positioned in front of the open front of the first cavity. In some embodiments, the metal cover includes a plurality of openings that provide access to the first cavity and to the second cavity.

In some embodiments, the first lip extends in parallel to a major surface of the metal cover and the second lip also extends in parallel to the major surface of the metal cover.

In some embodiments, the cavity phase shifter assembly further comprises a separator that is interposed between the metal housing and the metal cover. In some embodiments, the separator comprises a conductive separator. In some embodiments, the separator comprises a dielectric material, and the metal cover is capacitively coupled to the metal housing.

In some embodiments, a plurality of connectors attach the metal housing to the metal cover.

In some embodiments, the metal housing comprises sheet metal. In other embodiments, the metal housing comprises metallized plastic.

In some embodiments, the metal cover comprises sheet metal.

In some embodiments, the metal cover comprises a portion of a reflector of a base station antenna.

### BRIEF DESCRIPTION OF THE DRAWINGS

FIG. 1A is a front perspective view of a base station antenna that includes both passive linear arrays and an active beamforming array.

FIG. 1B is a schematic front view of the base station antenna of FIG. 1A with the radome removed.

FIG. 1C is a schematic side perspective view of a representative portion of a conventional low-band linear array assembly that may be used to implement the low-band linear array assemblies included in the base station antenna of FIGS. 1A-1B.

FIG. 1D is an end view of a cavity phase shifter assembly that is included in the low-band linear array assembly of FIG. 1C.

FIG. 1E illustrates one of the phase shifter printed circuit boards that is included in the cavity phase shifter assembly of FIG. 1D.

FIG. 2A is a schematic perspective view of a reflector for a base station antenna that includes a plurality of metal housings that are integrated with the reflector.

FIG. 2B is a schematic perspective view illustrating how the metal housings for a plurality of cavity phase shifter assemblies may be mounted on a frame.

FIG. 3A is a schematic end view of a cavity phase shifter assembly according to embodiments of the present invention.

FIG. 3B is a schematic front perspective view of one of the metal housings shown in FIG. 3A.

FIG. 3C is a schematic front perspective view of the metal cover shown in FIG. 3A.

FIG. 3D is an enlarged view of the portion of FIG. 3A that is within the box labelled 3D.

FIG. 3E is an end view of a mid-band linear array assembly according to embodiments of the present invention that includes the cavity phase shifter assembly of FIG. 3A and a linear array of mid-band radiating elements.

FIG. 3F is a schematic perspective view illustrating how the metal over of FIG. 3C may be part of a larger reflector of a base station antenna.

FIG. 4 is a schematic end view of a metal housing for a cavity phase shifter assembly according to further embodiments of the present invention.

It should be noted that herein like elements may be referred to individually by their full reference numeral and may be referred to collectively by the first part of their reference numeral.

### DETAILED DESCRIPTION

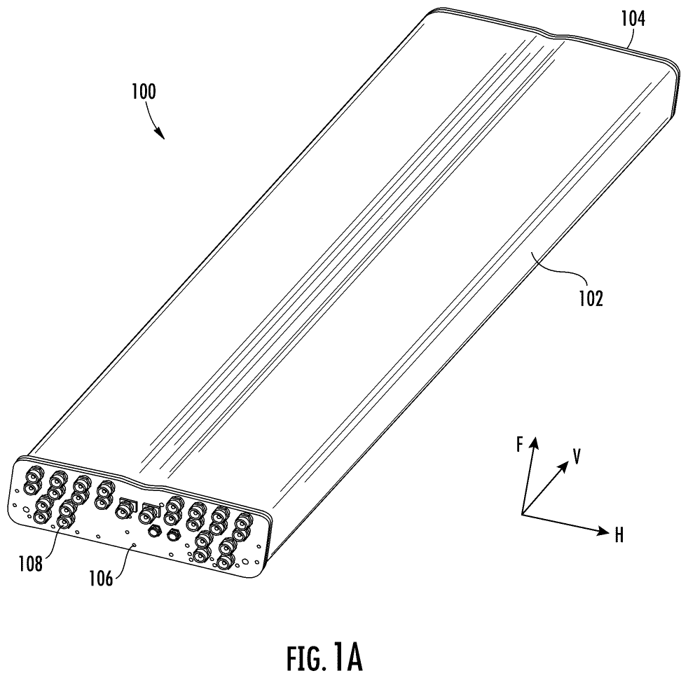

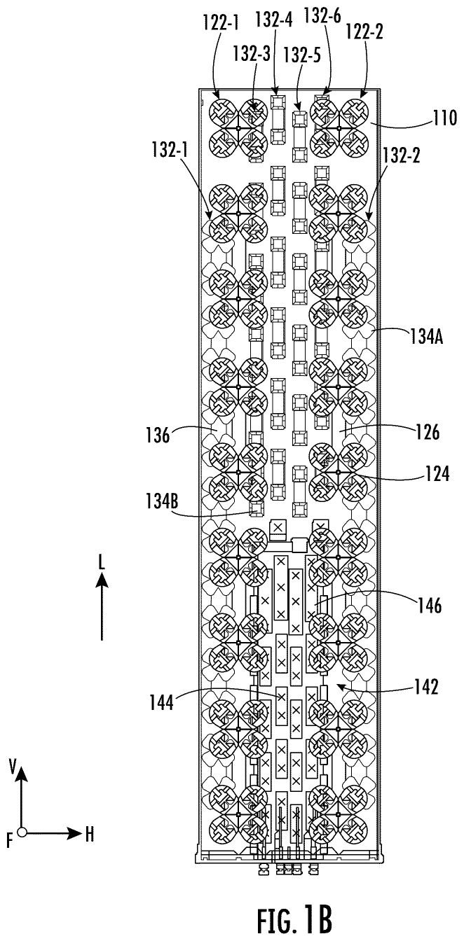

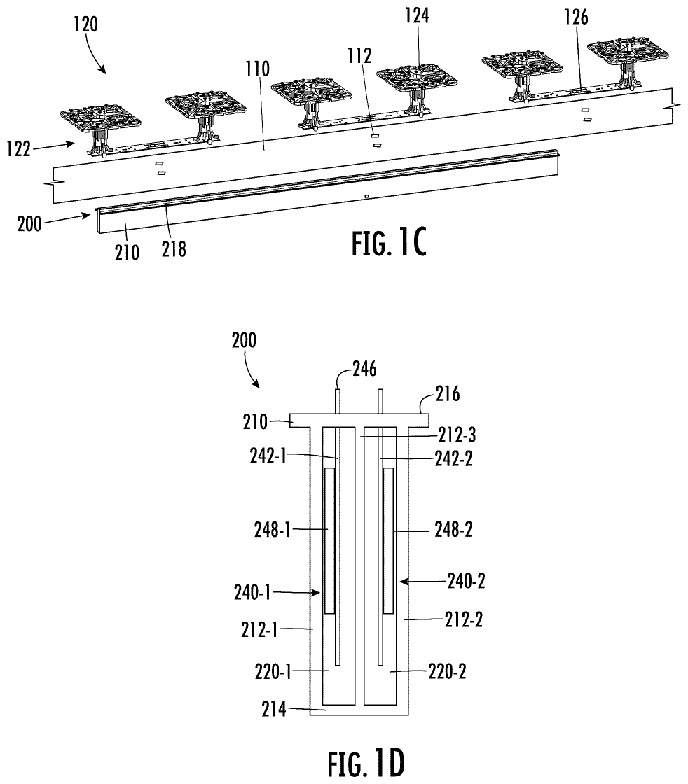

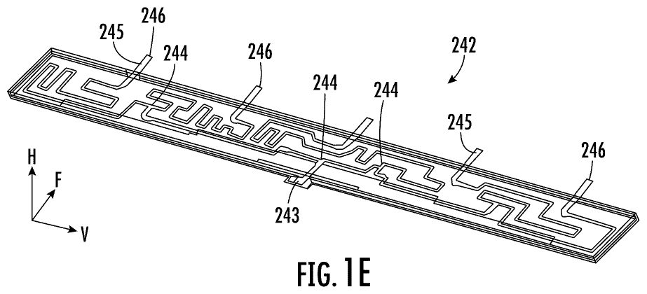

FIGS. 1A and 1B illustrate a base station antenna 100 that includes both passive low-band and mid-band linear arrays and a high-band active beamforming array. In particular, FIG. 1A is a front perspective view of the base station antenna 100, and FIG. 1B is a schematic front view of the base station antenna 100 with the radome thereof removed. In FIGS. 1A and 1B, the axes illustrate the vertical (V), horizontal (H) and forward (F) directions of the base station antenna system 100.

Referring to FIG. 1A, the base station antenna 100 includes a radome 102 a top end cap 104 and a bottom end cap 106. A plurality of RF ports 108 in the form of RF connectors are mounted in the bottom end cap 106. The RF ports 108 extend through the bottom end cap 106 and are used to electrically connect the base station antenna 100 to external radios (not shown). The radome 102, top end cap 104 and bottom cap 106 may form an external housing for the antenna 100. An antenna assembly (FIG. 1B) is contained within the housing.

FIG. 1B is a schematic front view of the antenna assembly that is contained within the housing of base station antenna 100. As shown in FIG. 1B, the antenna assembly includes a main reflector 110. The main reflector 110 may serve as both a structural component for the antenna assembly and as a ground plane and reflector for at least some of the radiating elements (discussed below) of antenna 100. The reflector 110 includes a generally flat metallic surface that extends in the longitudinal direction L of the antenna 100. Various components of base station antenna 100 (not shown) are mounted behind the reflector 110.

The antenna assembly further includes first and second low-band arrays 122-1, 122-2 of low-band radiating elements 124, first and second mid-band arrays 132-1, 132-2 of first mid-band radiating elements 134A, third through sixth mid-band arrays 132-3 through 132-6 of second mid-band radiating elements 134B, and a multi-column high-band array 142 of high-band radiating elements 144. The low-band arrays 122 and mid-band arrays 132 are each implemented as vertically-extending passive linear arrays that generate static antenna beams that provide coverage to a predefined coverage area (e.g., a 120° sector of a base station), with the only change to the coverage area occurring when the electronic downtilt angles of the generated antenna beams are adjusted. The high-band radiating elements 144 are mounted in four columns in the lower center portion of the reflector 110 to form the multi-column high-band array 142. Each column of the high-band array 142 may be coupled to a pair of ports (one for each polarization) of a beamforming radio so that the multi-column array 142 operates as an active beamforming array that generates narrowed antenna beams that can be steered in the azimuth plane throughout the coverage area.

The low-band radiating elements 124 are configured to transmit and receive signals in the 617-960 MHz frequency range or a portion thereof. The first and second mid-band radiating elements 134A, 134B are configured to transmit and receive signals in the 1427-2690 MHz frequency range or portions thereof, where the first and second mid-band radiating elements 134A, 134B may have different designs and have different operating frequency ranges (e.g., the first mid-band radiating elements 134A operate over the full 1427-2690 MHz frequency range while the second mid-band radiating elements 134B only operate in the 1695-2690 MHz frequency range). The high-band radiating elements 144 are configured to transmit and receive signals in the 3300-4200 MHz frequency range or a portion thereof. The radiating elements 124, 134A, 134B, 144 are mounted to extend forwardly from the reflector 110. The radiating elements 124, 134A, 134B, 144 may each be implemented as dual-polarized radiating elements that include first and second radiators that are configured to transmit and receive RF energy at orthogonal polarizations (e.g., slant −45°/+45° cross-dipole radiating elements).

Each of the low-band and mid-band linear arrays 122, 132 may be connected to a pair of the RF ports 108 that are used to connect each linear array 122, 132 to a respective pair of radio ports. A first feed network connects the first RF port 108 of each pair of RF ports 108 to the first polarization radiators of the radiating elements in a respective one of the linear arrays 122, 132, and a second feed network connects the second RF port 108 of each pair to the second polarization radiators of the radiating elements in the respective one of the linear arrays 122, 132. Accordingly, each linear array 122, 132 may be used to generate a respective antenna beam at each of two polarizations. Each feed network may include a phase shifter 240 for each polarization (see FIGS. 1C-1E) that includes a power divider that divides RF signals received from the radio into a plurality of sub-components that are fed to the respective first or second radiators of the radiating elements 124, 134A, 134B in the linear array 122, 132. Each phase shifter 240 may be used to apply a phase taper to the sub-components of the RF signal so that the generated antenna beams will have a desired amount of electrical downtilt. Each column of high-band radiating elements 144 is coupled to a pair of ports (one port for each polarization) of a beamforming radio (not shown).

As shown best in FIG. 1B, the low-band radiating elements 124 may be mounted on low-band feed board printed circuit boards 126, the mid-band radiating elements 134A, 134B may be mounted on mid-band feed board printed circuit boards 136, and the high-band radiating elements 144 may be mounted on high-band feed board printed circuit boards 146. The feed board printed circuit boards 126, 136, 146 couple RF signals between the radiating elements 124, 134A, 134B, 144 mounted thereon and the above-discussed phase shifters 240. Cables (not shown) may be used to connect each feed board 126, 136, 146 to the phase shifter 240.

A linear array and its associated feed network may be viewed as comprising a linear array assembly. Thus, base station antenna 100 includes, for example, two low-band linear array assemblies and six mid-band linear array assemblies. The linear array assemblies are not numbered in FIG. 1B as only the linear arrays 122, 132 are visible in FIG. 1B since the feed networks of the linear array assemblies are mostly behind the reflector 110. FIG. 1C below, however, illustrates a portion of a linear array assembly 120 that may be used to implement one of the low-band linear array assemblies of base station antenna 100.

The linear array assemblies according to embodiments of the present invention are implemented using cavity phase shifter assemblies. Cavity phase shifter assemblies are known in the art. For example, U.S. Pat. No. 11,677,141 discloses a variety of cavity phase shifter assemblies and discusses the operation thereof. The entire content of U.S. Pat. No. 11,677,141 is incorporated herein by reference. Cavity phase shifter assemblies may have certain advantages over non-cavity phase shifter assemblies as they include shielded stripline RF transmission lines and because they can be designed to provide cableless connections to the radiating elements, which reduces the number of solder joints and the weight of coaxial phase cables.

FIG. 1C is a schematic side perspective view of a representative portion of a linear array assembly 120 that may be used in in base station antenna 100. The linear array assembly 120 includes a linear array 122 and a cavity phase shifter assembly 200. FIG. 1C also shows the low-band radiating elements 124 and feedboards 126 that are fed by the cavity phase shifter assembly 200. FIG. 1D is an end view of the cavity phase shifter assembly 200 of FIG. 1C, and FIG. 1E is a schematic perspective view of one of the phase shifter printed circuit boards 242 that are included in the cavity phase shifter assembly 200 of FIGS. 1C-1D.

Referring first to FIGS. 1C and 1D, the cavity phase shifter assembly 200 includes a metal housing 210 that includes a pair of outer sidewalls 212-1, 212-2, a (shared) inner sidewall 212-3, a rear wall 214, and a front wall 216 that together define first and second longitudinally-extending cavities 220-1, 220-2. The cavity phase shifter assembly 200 includes first and second phase shifters 240-1, 240-2 that are mounted in the respective first and second cavities 220-1, 220-2. Each phase shifter 240 may be implemented, for example, as a sliding dielectric phase shifter that includes a phase shifter printed circuit board 242 and a sliding dielectric block 248. This allows the cavity phase shifter assembly 200 to feed the dual-polarized low-band linear array 120 (i.e., a feed network is provided for each polarization).

The cavity phase shifter assembly 200 is mounted behind the reflector 110 of base station antenna 100. A thin dielectric layer may be interposed between the reflector 110 and the cavity phase shifter assembly 200 so that they are capacitively coupled to each other, thereby grounding the metal housing 210 of the cavity phase shifter assembly 200. Since the phase shifter printed circuit boards 242 are mounted in a grounded metal housing 210, the RF transmission lines on the phase shifter printed circuit boards 242 operate as stripline transmission lines, which reduces RF losses and shields the RF transmission lines from external RF sources.

FIG. 1E illustrates one of the phase shifter printed circuit boards 242 of FIG. 1D. As shown in FIG. 1E, each phase shifter printed circuit board 242 may include an input port 243 that receives the RF signals output by an associated radio. The input port 243 is connected to metal traces that pass the received RF signals through a plurality of T-junctions 244 that together act as a power divider that splits the received RF signals input at the input port 243 into a plurality of sub-components. Each phase shifter printed circuit board 242 further includes a plurality of output RF transmission lines 245 where the phase adjusted sub-components of the RF signal are output from the phase shifter printed circuit board 242. As shown in FIG. 1E, each output RF transmission line 245 extends onto a respective one of a plurality of forwardly-extending tabs 246. As shown in FIG. 1D, each phase shifter assembly 240 also includes a sliding dielectric piece 248 that is mounted adjacent the phase shifter printed circuit board 242. The sliding dielectric pieces 248 are configured to impart an adjustable phase taper to the sub-components of the RF signal before they reach the respective output RF transmission lines 245.

Referring again to FIGS. 1C-1D, openings 218 are provided in a front wall 216 of the metal housing 210 and openings 112 are provided in the reflector 110. The above-discussed forwardly-extending tabs 246 on each phase shifter printed circuit board 242 extend through the openings 218 in the front wall 216 of the metal housing 210 and through aligned openings 112 in the reflector 110 and into openings in the respective low-band feed boards 126. Solder joints may be applied to physically and electrically connect each output RF transmission line 245 to respective RF transmission lines on the low-band feed board printed circuit boards 126. Each low-band feed board 126 may include a pair of power dividers that split the RF signals provided thereto through the output RF transmission lines 245 of the phase shifter printed circuit boards 242 and pass the sub-components of the split RF signals to the appropriate radiators of the low-band radiating elements 124. This eliminates the need for the above-mentioned coaxial phase cables and reduces the number of solder joints required.

The forwardly-extending tabs 246 increase the extent of each phase shifter printed circuit board 242 in the forward direction of the base station antenna 100. Since the cavities 220 are closed on all four major sides (namely the front, rear and sidewalls), each phase shifter printed circuit board 242 is inserted into the respective cavities 220 from either the top or bottom ends thereof (which are open). As shown in FIG. 1D, each cavity 220 must therefore be formed deeper than the extent in the depth direction of the portions of the phase shifter printed circuit boards 242 that do not include the tabs 246, so that the phase shifter printed circuit boards 242 may be inserted into the respective cavities 220.

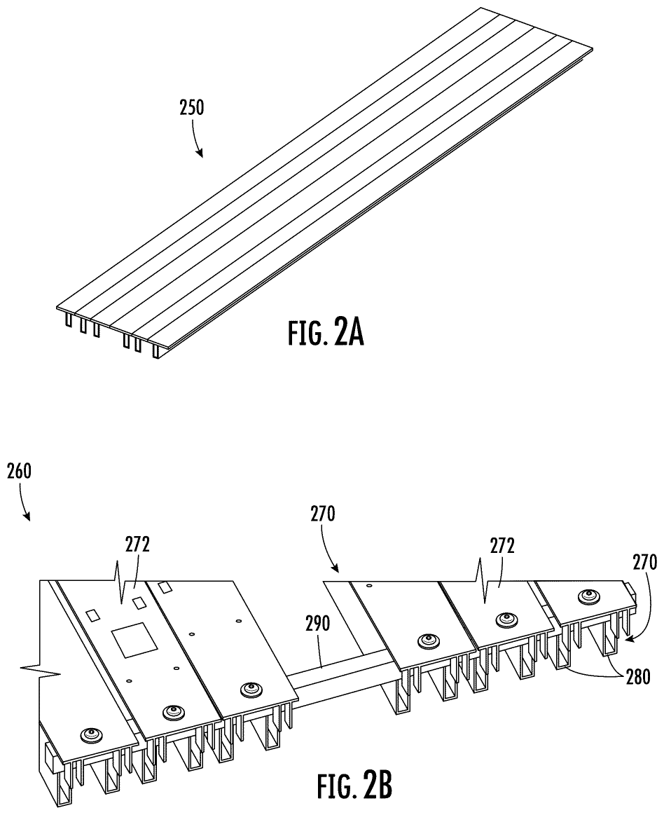

While the conventional cavity phase shifter assembly 200 of FIGS. 1C-1E has a number of advantages over non-cavity phase shifter assemblies, it can be difficult to manufacture. In base station antennas that include cavity phase shifter assemblies, typically, many or all of the linear arrays included in a base station antenna may have an associated cavity phase shifter assembly. In some cases, the cavity phase shifter assemblies can be formed by extruding the metal housings for all of the cavity phase shifter assemblies and the reflector as a single monolithic structure 250, as shown in FIG. 2A. While this provides a structurally sound frame for the antenna, it can be difficult and expensive to form the large monolithic structure 250 shown in FIG. 2A. To overcome this difficulty, a base station antenna 260 may include a plurality of metal housings 270 that are separately extruded, as shown in FIG. 2B. Each metal housing 270 will typically have two cavities 280 formed therein so that the metal housing 270 may include the phase shifters for both polarization radiators of a linear array. The metal housings 270 may be mounted on a frame 290 as shown, with a small separation provided between adjacent metal housings 270 in order to avoid contact between adjacent metal housings 270 that might otherwise act as a potential source of passive intermodulation (“PIM”) distortion. In some cases, the front walls 272 of the metal housings 270 may serve as the reflector of the base station antenna. In other cases, a separate reflector (not shown) may be mounted on the front walls 272 of the metal housings 270 with a thin dielectric layer interposed therebetween so that each metal housing 270 capacitively couples to the separate reflector. In the embodiment of FIG. 2B, each metal housing 270 may be a monolithic element that includes a pair of cavities 280 formed therein. The cavities 280 may have a front wall, a pair of sidewalls and a rear wall, and may be open on each end as shown. Openings may be provided in some of the walls. For example, as shown in FIG. 2B, openings may be provided in the front walls 272 so that the outputs of the phase shifters may be connected to the feedboard printed circuit boards in the same manner discussed above with reference to FIG. 1C. While the smaller metal housings 270 shown in FIG. 2B may be easier to manufacture than the large composite structure 250 shown in FIG. 2A, the extrusion process is still expensive. Additionally, if a separate reflector is not provided the performance of the linear arrays may be degraded to a degree, and if a reflector is provided it increases the weight, cost and manufacturing complexity.

Pursuant to embodiments of the present invention, base station antennas are provided that include cavity phase shifter assemblies that may be cheaper to manufacture and which can exhibit increased performance and/or may be smaller than conventional cavity phase shifter assemblies. The cavity phase shifter assemblies according to embodiments of the present invention may comprise one or more metal housings and a separate metal cover. Each metal housing may comprise, for example, a sheet metal housing that is stamped from a piece of sheet metal and then bent to define one or more cavities that have open fronts. The metal cover may be positioned forwardly of the metal housing so that it covers the open front of each cavity. The metal cover may comprise, for example, a sheet metal cover. The metal housing may be attached to the metal cover using a plurality of connectors such as bolts and nuts or twist-lock connectors. A thin dielectric element such as a gasket may be interposed between the metal housing and the metal cover so that the metal housing is capacitively coupled to the metal cover. In other embodiments, a conductive element such as a conductive rubber gasket or a conductive double-sided fabric tape may be interposed between the metal housing and the metal cover so that the metal housing is galvanically coupled to the metal cover in a manner that will not be a source of PIM distortion.

Each metal housing may include a pair of sidewalls that extend in the longitudinal direction and a rear wall that connects the rear edges of the two sidewalls. A cavity is defined in between the two sidewalls and the rear wall. The cavities are open in the front (i.e., the metal housing does not include front walls that enclose the front of each respective cavity). The metal housing may include lips that extend outwardly from the front of each sidewall. These lips may have openings that allow each metal housing to be attached to the metal cover by connectors that extend through the openings and through openings in the metal cover. Ends (in the longitudinal direction) of each cavity may be open in some embodiments.

Phase shifters may be mounted in each cavity. Each phase shifter may comprise, for example, a phase shifter printed circuit board and one or more sliding dielectric blocks that together implement a sliding dielectric phase shifter. In some embodiments, the phase shifter printed circuit boards may include forwardly-extending tabs, and the output RF transmission lines may extend onto the respective forwardly-extending tabs. The forwardly-extending tabs may extend through opening in the metal cover so that the forwardly-extending tabs are on the front side of the reflector of the base station antenna (note that the metal cover may act as the reflector).

The metal housing may be attached to the metal cover so that the metal cover acts to form a front wall for each cavity. Since the cavities are open in the front before the metal cover is attached, each phase shifter printed circuit board may be installed in its respective cavity by inserting the phase shifter into its respective cavity from the front. Since the phase shifter printed circuit boards are installed from the front, the cavities may have the same depth as the portions of the phase shifter printed circuit boards that do not include the forwardly-extending tabs, as those tabs extend through openings in the metal cover when the metal housings are attached to the metal cover. In contrast, with conventional cavity phase shifter assemblies that have cavities that are only open at the ends thereof, the depth of the cavity must be at least as large as the portions of the phase shifter printed circuit boards that include the forwardly-extending tabs. Thus, the cavity phase shifters according to embodiments of the present invention may have reduced depths.

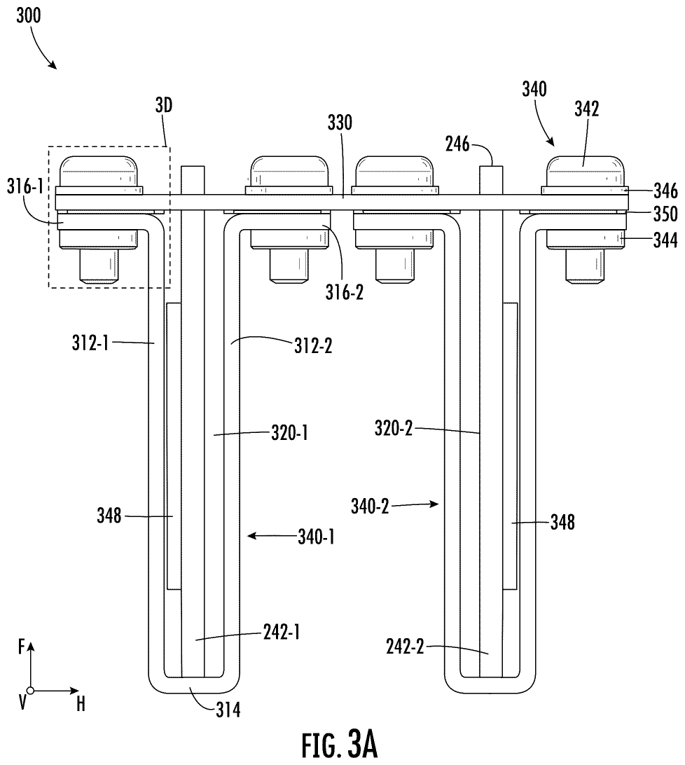

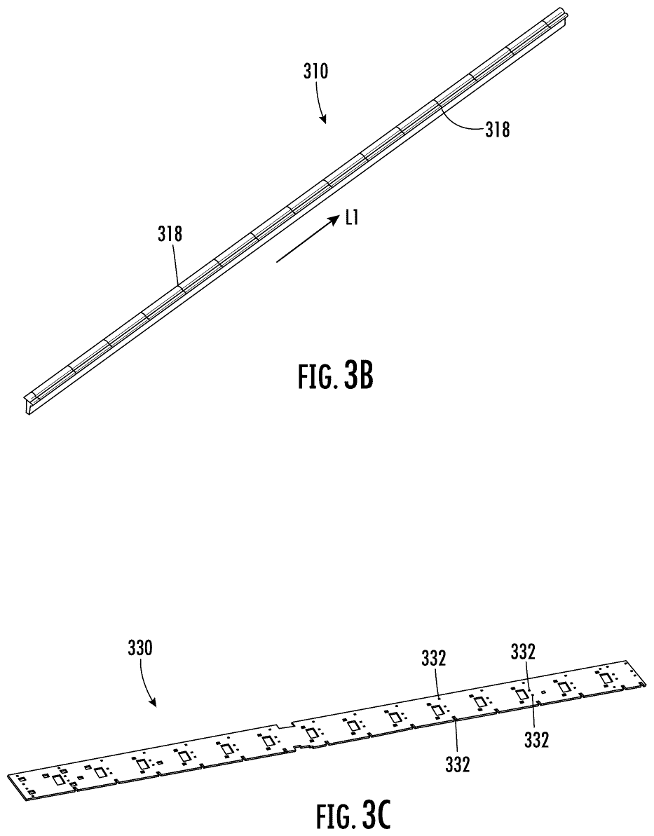

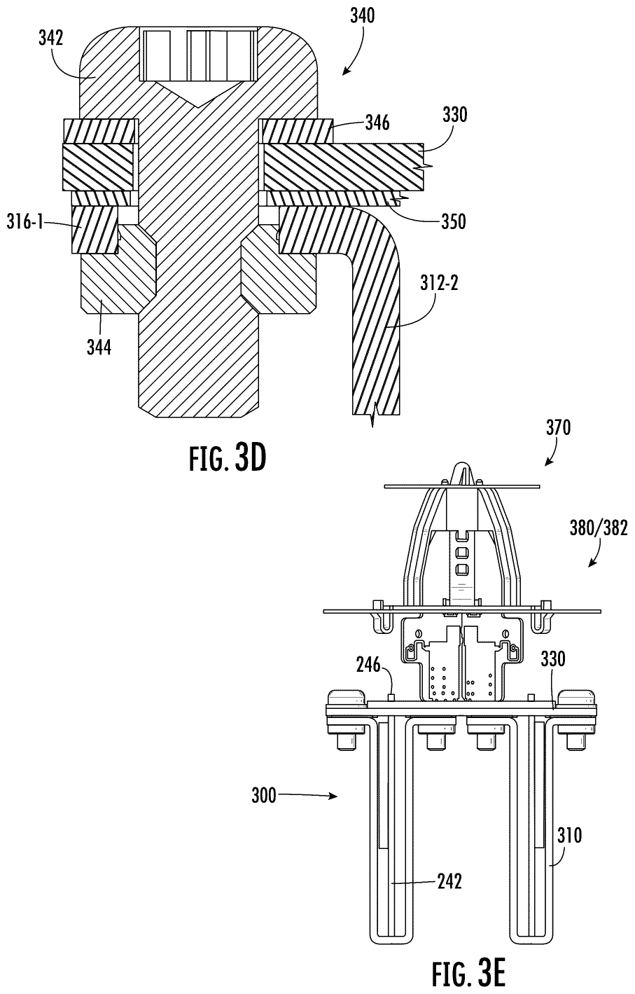

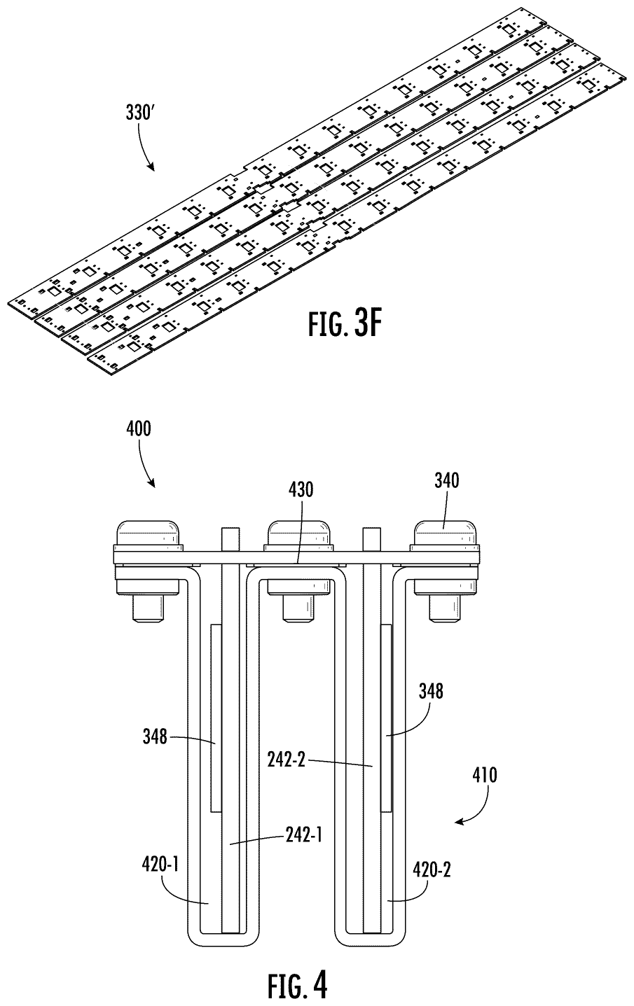

Embodiments of the present invention will now be described in greater detail with reference to FIGS. 3A-4, which show example cavity phase shifter assemblies according to embodiments of the present invention. The cavity phase shifter assemblies shown in FIGS. 3A-4 may, for example, be used in the base station antenna 100 of FIGS. 1A-1B in place of the cavity phase shifter assembly 200 depicted in FIGS. 1C-1E.

FIG. 3A is a schematic end view of a cavity phase shifter assembly 300 according to embodiments of the present invention. FIG. 3B is a schematic front perspective view of one of the metal housings 310 of the cavity phase shifter assembly 300 of FIG. 3A. FIG. 3C is a schematic front perspective view of the metal cover 330 shown in FIG. 3A. FIG. 3D is an enlarged view of the portion of FIG. 3A that is within the box labelled 3D.

As shown in FIG. 3A, the cavity phase shifter assembly 300 includes first and second metal housings 310-1, 310-2 and a metal cover 330. The cavity phase shifter assembly 300 further includes a plurality of connectors 340 such as bolt and nut pairs that are used to attach the metal housings 310-1, 310-2 to the metal cover 330. A gasket or other separator 350 may be interposed between the metal cover 330 and the metal housings 310-1, 310-2.

Referring to FIGS. 3A and 3B, each metal housing 310 may extend along a respective longitudinal axis L1. In some embodiments, the metal housings 310 may be formed from sheet metal using stamping and bending operations that are well understood by those of skill in the art. Sheet metal housings 310 may be formed at very low cost. In other embodiments, each metal housing 310 may comprise a plastic extrusion with a metal film or metal plating formed on at least one side thereof.

As shown in FIG. 3A, each metal housing 310 comprises a first sidewall 312-1, a second sidewall 312-2, and a rear wall 314. The rear wall 314 may be integral with the first and second sidewalls 312-1, 312-2 and may connect rear edges of the first and second sidewalls 312-1, 312-2, as shown. A first lip 316-1 may extend outwardly from a forward edge of the first sidewall 312-1, and a second lip 316-2 may extend outwardly from a forward edge of the second sidewall 312-2. The first and second lips 316-1, 316-2 may be integral with the first and second sidewalls 312-1, 312-2 and may extend outwardly (i.e., away from each other) from front edges of the first and second sidewalls 312-1, 312-2, as shown. When the cavity phase shifter assembly 300 is mounted in base station antenna 100, the first and second sidewalls 312-1, 312-2 may have major surfaces that extend in the vertical and forward directions of the base station antenna 100, while the rear wall 314 and the first and second lips 316-1, 316-2 may have major surfaces that extend in the vertical and horizontal directions of the base station antenna 100. As shown in FIG. 3B, the length of each metal housing 310 in the vertical direction may be much greater than the width of the metal housing 310 in the horizontal direction or the depth of the metal housing 310 in the forward direction.

The first and second sidewalls 312-1, 312-2 and the rear wall 314 of each metal housing 310 together define a longitudinally-extending cavity 320. As shown in FIG. 3B, the metal housings 310 do not include any front walls that enclose the front of the cavities 320 so that each cavity 320 has an open front. Likewise, the metal housings 310 do not include top or bottom walls that cover the respective top and bottom ends of each cavity 320 so that each cavity 320 may also have open ends.

In some embodiments each pair of metal housings 310 may have an associated metal cover 330. In other embodiments, a single metal cover may be provided that acts as the metal cover for all of the metal housings 310 included in a base station antenna. In such cases, the single metal cover may also act as the reflector for the base station antenna. FIG. 3F illustrates a metal cover 330′that may act as the reflector of a base station antenna and that may act as the metal cover for eight metal housings 310 (not shown in FIG. 3F).

The connectors 340 are used to attach the metal housings 310-1, 310-2 to the metal cover 330. In the depicted embodiment each connector 340 comprises a bolt 342 with a cooperating nut 344. Each lip 316 may include a plurality of openings 318 such as holes or slots along the length of the lip 316 as shown best in FIG. 3B. The metal cover 330 may similarly include a plurality of openings 332 (e.g., holes or slots) that are aligned with the openings 318 in the respective lips 316 as best shown in FIG. 3C. In the depicted embodiment, each connector 340 comprises the combination of a bolt 342 and a nut 344. The bolts 342 may be inserted through the openings 318, 322 from the front side and the nuts 344 may be tightened onto the respective bolts 342 from the back side so that the lips 316 of the metal housings 310 and the metal cover 330 are captured therebetween, thereby attaching each metal housing 310 to the metal cover 330. The rear surface of the metal cover 330 may extend in a plane that is parallel to a plane defined by the front surface of the first lip 316-1 and/or in a plane that is parallel to a plane defined by the front surface of the second lip 316-2.

While the connectors 340 are implemented as bolt/nut connectors 340 in FIG. 3A, it will be appreciated that any appropriate connectors 340 may be used. For example, quarter-turn or half-turn connectors may be used in other embodiments. An example of a representative quarter-turn connector that could be used in place of the bolt-nut pairs shown in FIG. 3A is disclosed in U.S. Pat. No. 10,907,675, issued Feb. 2, 2021, the entire content of which is incorporated herein by reference.

As is known in the art, inconsistent metal-to-metal connections may generate PIM distortion in an RF communications system. In order to prevent (or at least reduce the risk of) such PIM distortion, one or more separators 350 such as a plurality of gaskets may be interposed in between the metal housings 310 and the metal cover 330 to prevent the metal cover 330 and the metal housings 310 from coming into direct contact with each other. In some embodiments, the separators 350 may comprise thin dielectric materials. In such embodiments, the metal cover 330 may be capacitively coupled to the metal housings 310 through the dielectric separator 350. In other embodiments, the separators 350 may comprise conductive materials such as conductive rubber gaskets or double-sided conductive fabric tapes. In such embodiments, the metal cover 330 may be galvanically connected to the metal housings 310 through the conductive separators 350. In some embodiments, the conductive separators 350 may comprise resilient materials and the connectors 340 may be tightened to ensure that a consistent electrical connection is provided between the separator 350 and the metal housing 310 on one side and the metal cover 330 on the other side. Each connector 340 may further include a washer 346, as shown.

Referring again to FIG. 3A, a first phase shifter 340-1 is mounted in the first cavity 320-1, and a second phase shifter 340-2 is mounted in the second cavity 320-2. Each phase shifter 340 may comprise, for example, a phase shifter printed circuit board 242 with RF transmission lines formed thereon and one or more sliding dielectric blocks 348. The phase shifter printed circuit board 242 may be identical to the phase shifter printed circuit board 242 shown in FIG. 1E so it is identified using the same reference numeral and further description thereof will be omitted here.

FIG. 3E is an end view of a mid-band linear array assembly 370 that includes a cavity phase shifter assembly 300 according to embodiments of the present invention and a linear array 380 of mid-band radiating elements 382. The mid-band linear array assembly 380 may, for example, be used to implement one of the mid-band linear array assemblies of the base station antenna 100 of FIGS. 1A-1B. The mid-band cavity phase shifter assembly 300 may be connected to a pair of the RF ports 108 of the base station antenna 100 (one RF port for each of the two polarizations) by respective RF feed cables (not shown).

As discussed above, the metal cover 330 shown in FIG. 3E may be a portion of the main reflector 110 of base station antenna 100. The metal housing 310 is mounted rearwardly of the metal cover 330/reflector 110, while the mid-band radiating elements 382 are mounted forwardly of the metal cover 330/reflector 110. A plurality of openings 332 (FIG. 3C) are provided in the metal cover 330/reflector 110 to allow output RF transmission lines on the forwardly-extending tabs 246 of the phase shifter printed circuit boards 242 to extend out of the cavities 320 to connect to feed board printed circuit boards of the mid-band linear array 380 or directly to the radiating elements 382. While not shown in the figures, in other embodiments, feed stalks for the radiating elements may have rearwardly-extending tabs that pass through the openings 332 in the metal cover 330/reflector 110 so that the signal traces and/or ground lines on the feed stalks may be electrically connected to the outputs of the phase shifter printed circuit boards 242 (e.g., by soldering).

The cavity phase shifter assembly 300 may be cheaper to manufacture than the cavity phase shifter assemblies discussed above with reference to FIGS. 1C-1E and 2A-2B. In addition, the cavity phase shifter assembly 300 may be smaller than many conventional cavity phase shifter assemblies. As discussed above with reference to FIG. 1E, in many instances the phase shifter printed circuit boards 242 that are used in cavity phase shifter assemblies may have forwardly-extending tabs 246 that extend out of the front wall of the metal housing that defines the cavities to physically and electrically connect with feedboard printed circuit boards of a linear array or to directly connect to the radiating elements of the linear array. Since conventional metal housings for cavity phase shifters have two sidewalls, a rear wall and a front wall and hence are only open on their upper and lower ends, the phase shifter printed circuit boards for such cavity phase shifter assemblies are inserted into the cavity from either the upper or lower ends. If these printed circuit boards include the forwardly-extending tabs 246, then the depth of each cavity must be at least as large as the width of the phase shifter printed circuit boards 242 including the forwardly-extending tabs 246 (i.e., the extent of the phase shifter printed circuit boards in the depth direction when the phase shifter printed circuit boards are mounted within the cavities), even though the phase shifter printed circuit board 242 will be pushed forwardly when installed within the cavity so that the forwardly-extending tabs 246 extend through the front wall of the metal housing. In other words, the depth of the cavity must be increased by the length of the forwardly-extending tabs 246 in the forward direction so that the phase shifter printed circuit boards 242 can be inserted into the respective cavities. This requires a larger metal housing with increases the size, weight, and cost of the cavity phase shifter assembly.

In contrast, the cavity phase shifter assemblies according to embodiments of the present invention have cavities 320 that have an open front, which allows the phase shifter printed circuit boards 242 to easily be inserted into the respective cavities (before the metal housing 310 is attached to the metal cover 330) so that the forwardly-extending tabs 246 extend forwardly out of the cavities 320 while a rear edges of the phase shifter printed circuit boards 242 rest against the rear walls 314 of the cavities 320. Consequently, the cavities 320 can be sized to have a depth that is equal to the extent in the depth direction of portions of the phase shifter printed circuit board 242 that do not include the forwardly-extending tabs 246, and hence the cavities 320 can be shallower than many conventional cavities.

This design can be particularly beneficial if used in base station antennas in which the forwardly-extending tabs 246 of the phase shifter printed circuit boards 242 act as part of the feed stalk of the radiating elements 382 of the linear array 380 associated with the cavity phase shifter assembly 300. In such base station antennas, the forwardly extending tabs 246 typically have a length in the depth (forward) direction of more than a quarter of a wavelength of the center frequency of the operating frequency band of the radiating elements. Such base station antennas are described in U.S. Provisional Patent Application Ser. No. 63/680,302, filed Aug. 7, 2024 (herein “the '302 application”), the entire content of which is incorporated herein by reference. Because it typically would be commercially impractical to increase the depth of the cavity to match the depth of the phase shifter printed circuit boards disclosed in the '302 application, the '302 application propose partially or completely omitting the rear walls of the metal housings of the cavity phase shifters disclosed therein. This, however, may cause unwanted resonances that may need to be addressed and may increase RF losses and/or interference from other RF sources. By providing cavities 320 that open fronts that can later be covered via a detachable metal cover 330, the cavity phase shifter assemblies 300 according to embodiments of the present invention may provide improved performance.

Referring again to FIGS. 3A-3E, pursuant to some embodiments of the present invention, cavity phase shifter assemblies 300 are provided that comprise a metal housing 310 that extends along a longitudinal axis L1, the metal housing 310 having a first sidewall 312-1 and a second sidewall 312-2 that are connected by a rear wall 314 to define a first cavity 320 having an open front and a metal cover 330 that is positioned in front of the open front of the first cavity 320.

The metal housing 310 may further comprise a first lip 316-1 that extends away from the first cavity 320 and a second lip 316-2 that also extends away from the first cavity 320. The first lip 316-1 may extend in parallel to a major surface of the metal cover 330 (e.g., a rear surface of the metal cover 330) and the second lip 316-2 may also extend in parallel to the major surface of the metal cover 330. The cavity phase shifter assembly may also include a separator 350 that is interposed between the metal housing 310 and the metal cover 330. The separator 350 may comprise a dielectric separator (e.g., a rubber or plastic gasket) or may be formed of a conductive material (e.g., a conductive rubber separator or a double-sided conductive fabric tape in example embodiments). The metal cover 330 may include a plurality of openings 332 that provide access to the first cavity 320.

The cavity phase shifter assembly 300 may further comprise a plurality of connectors 340 such as, for example, a plurality of pairs of bolts 342 and nuts 344 or a plurality of twist connectors. The connectors 340 may be used to removably attach the metal housing 310 to the metal cover 330.

In some embodiments, the metal housing 310 may comprise stamped and bent sheet metal. In other embodiments, the metal housing 310 may comprise an extruded or molded plastic frame that has a metallized film or metal plating on at least one side thereof. In some embodiments, the metal cover 330 may comprise a piece of sheet metal. The sheet metal cover 330 may be stamped from a larger piece of sheet metal and openings may be punched therein. In some embodiments, the sheet metal cover 330 may also be bent (e.g., at the edges to form support lips, RF chokes or the like). In some embodiments, the metal cover 330 may comprise a main reflector of a base station antenna that acts as a reflector for a plurality of arrays of radiating elements.

The cavity phase shifter assembly 300 may further include a phase shifter printed circuit board 242 in the first cavity 320. The phase shifter printed circuit board 242 may include one or more forwardly-extending tabs 246 that extend through respective openings 332 in the metal cover 330.

FIG. 4 is a schematic end view of a cavity phase shifter assembly 400 according to further embodiments of the present invention. The cavity phase shifter assembly 400 may be very similar to the cavity phase shifter assembly 300 of FIGS. 3A-3D, but differs in that it includes a single metal housing 410 that defines two cavities 420-1, 420-2 as opposed to having two separate metal cavities 310-1, 310-2 that define two respective cavities 320-1, 320-2 as is the case with cavity phase shifter assembly 300.

The cavity phase shifter assembly 400 may allow the two cavities 420-1, 420-2 to be positioned closer to each other, and may require less sheet metal to implement, reducing the weight of the antenna and material costs. It may also require fewer connectors 340, further reducing cost and simplifying assembly of the antenna. As the cavity phase shifter assembly 400 may otherwise be identical to cavity phase shifter assembly 300, further description of cavity phase shifter assembly 400 is omitted here.

As shown in FIG. 4, pursuant to further embodiments of the present invention, cavity phase shifter assemblies 400 are provided that comprise a metal housing 410 that includes a first cavity 420-1 that has an open front and a second cavity 420-2 that also has an open front. A first phase shifter 240-1 is mounted in the first cavity 420-1 and a second phase shifter 240-2 is mounted in the second cavity 420-2. These cavity phase shifter assemblies 400 further comprise a metal cover 430 that is positioned in front of the open front of the first cavity 420-1 and in front of the open front of the second cavity 420-2.

The present invention has been described above with reference to the accompanying drawings. The present invention is not limited to the illustrated embodiments. Rather, these embodiments are intended to fully and completely disclose the present invention to those skilled in this art. In the drawings, like numbers refer to like elements throughout. Thicknesses and dimensions of some components may be exaggerated for clarity.

Spatially relative terms, such as “under,” “below,” “lower,” “over,” “upper,” “top,” “bottom,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the example term “under” can encompass both an orientation of over and under. The device may be otherwise oriented (rotated 90 degrees or at other orientations) and the spatially relative descriptors used herein interpreted accordingly.

Herein, the terms “attached,” “connected,” “interconnected,” “contacting,” “mounted,” “coupled,” and the like can mean either direct or indirect attachment or coupling between elements, unless stated otherwise.

Well-known functions or constructions may not be described in detail for brevity and/or clarity. As used herein the expression “and/or” includes any and all combinations of one or more of the associated listed items.

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “comprises,” “comprising,” “includes,” and/or “including” when used in this specification, specify the presence of stated features, operations, elements, and/or components, but do not preclude the presence or addition of one or more other features, operations, elements, components, and/or groups thereof.

1. A cavity phase shifter assembly, comprising:
a metal housing that extends along a longitudinal axis, the metal housing having a first sidewall and a second sidewall that are connected by a rear wall to define a first cavity having an open front; and
a metal cover that is positioned in front of the open front of the first cavity.

2. The cavity phase shifter assembly of claim 1, wherein the metal cover includes a plurality of openings that provide access to the first cavity.

3-4. (canceled)

5. The cavity phase shifter assembly of claim 1, further comprising a dielectric material that is interposed between the metal housing and the metal cover.

6. (canceled)

7. The cavity phase shifter assembly of claim 1, the metal housing further comprising a third sidewall and a fourth sidewall that are connected by a second rear wall to define a second cavity having an open front.

8. The cavity phase shifter assembly of claim 7, wherein the metal cover is positioned in front of the open front of the second cavity.

9. The cavity phase shifter assembly of claim 1, wherein a plurality of connectors attach the metal housing to the metal cover.

10-13. (canceled)

14. The cavity phase shifter assembly of claim 2, further comprising a phase shifter printed circuit board in the first cavity, wherein the phase shifter printed circuit board includes a forwardly-extending tab that extends through a first of the openings in the metal cover.

15. A cavity phase shifter assembly, comprising:
a metal housing that includes a first cavity that has an open front and a second cavity that has an open front;
a first phase shifter assembly in the first cavity;
a second phase shifter assembly in the second cavity; and
a metal cover that is positioned in front of the open front of the first cavity and the open front of the second cavity.

16. (canceled)

17. The cavity phase shifter assembly of claim 15, wherein the metal housing comprises:
a first sidewall and a second sidewall that are connected by a first rear wall to define the first cavity; and
a third sidewall and a fourth sidewall that are connected by a second rear wall to define the second cavity.

18-19. (canceled)

20. The cavity phase shifter assembly of claim 15, further comprising a separator that is interposed between the metal housing and the metal cover.

21. The cavity phase shifter assembly of claim 20, wherein the separator comprises a resilient conductive separator.

22. The cavity phase shifter assembly of claim 20, wherein the separator comprises a dielectric material, and the metal cover is capacitively coupled to the metal housing.

23. (canceled)

24. The cavity phase shifter assembly of claim 15, wherein the metal housing comprises sheet metal.

25. The cavity phase shifter assembly of claim 15, wherein the metal housing comprises metallized plastic.

26. The cavity phase shifter assembly of claim 15, wherein the metal cover comprises sheet metal.

27. The cavity phase shifter assembly of claim 15, wherein the metal cover comprises a portion of a reflector of a base station antenna.

28. (canceled)

29. A cavity phase shifter assembly, comprising:
a metal housing that extends along a first longitudinal axis, the metal housing comprising:
a first sidewall;
a second sidewall;
a rear wall that connects the first sidewall to the second sidewall;
a first lip that extends outwardly from a front edge of the first sidewall; and
a second lip that extends outwardly from a front edge of the second sidewall; and
a metal cover that extends in parallel to the first and second lips.

30. The cavity phase shifter assembly of claim 29, wherein the first sidewall, the second sidewall and the rear wall define a first cavity having an open front, and the metal cover is positioned in front of the open front of the first cavity.

31. (canceled)

32. The cavity phase shifter assembly of claim 29, wherein the first lip extends in parallel to a major surface of the metal cover and the second lip also extends in parallel to the major surface of the metal cover.

33-35. (canceled)

36. The cavity phase shifter assembly of claim 29, wherein a plurality of connectors attach the metal housing to the metal cover.

37-39. (canceled)

40. The cavity phase shifter assembly of claim 29, wherein the metal cover comprises a portion of a reflector of a base station antenna.

41. The cavity phase shifter assembly of claim 15, wherein a rear edge of the phase shifter printed circuit board contacts a rear wall of the metal housing.
